(19) United States
(12) Patent Application Publication
(10) Pub. No.: US 2002/0077150 A1
(43) Pub. Date: Jun. 20, 2002

(54) BASE STATION WITH ANTENNA, INCLUDING AN AMPLIFIER, LOCATED AT A DISTANCE FROM THE BASE STATION

(76) Inventor: PAUL CLIFFORD, HAMPSHIRE (GB)

Correspondence Address: MICHAEL B. LASKY, Altera Law Group, LLC, 6500 City West Parkway- Suite 100, Minneapolis, MN, 55344-7701, US

(21) Appl. No.: 09/202,304

(22) PCT Filed: Jul. 18, 1997
(86) PCT No.: PCT/FI97/00453

(30) Foreign Application Priority Data
Jul. 24, 1996 (GB) 9615547.8

(51) Int. Cl. H04M 1/00

(52) U.S. Cl. 455/561

(57) ABSTRACT

The present invention relates to a base station of a radio system, comprising a base station equipment including at least one transmitter unit, and antenna means adapted at a distance from said base station equipment and connected by at least one cable to the transmitter unit of said base station equipment for receiving signals fed by said transmitter unit and for forwarding said signals to receiver units within the radio coverage area of the base station. The antenna means of the base station include amplifying means for amplifying the signals received from the transmitter unit via said cable and for forwarding the amplified signals to said receiver units. Thus the radio coverage area of the base station can be increased without simultaneously increasing the feeder losses from transmitter to antenna.

The invention relates to a base station of a radio system, comprising a base station equipment including at least one transmitter unit, and antenna means adapted at a distance from said base station equipment and connected by at least one cable to the transmitter unit of said base station equipment for receiving signals fed by said transmitter unit, said antenna means including amplifying means for amplifying the signals received form the transmitter unit via said cable and means for forwarding the amplified signals to receiver units within the radio coverage area of the base station.

The invention relates to a base station such as a base station of a cellular communication system, where the antenna means of the base station are adapted at a distance from the base station equipment. In known base stations the antenna means are usually adapted in an antenna mast and the base station equipment is usually located at the foot of the antenna mast, which means that the antenna means are spaced apart from the base station equipment. In such known base stations the antenna mast usually comprise passband filters/duplex filters and one or several antennas or antenna elements for forwarding signals received from the transmitters of the base station equipment.

The invention relates especially to the size of the radio coverage area of a base station. It is desirable that the radio coverage area of a base station could be as large as possible in sparsely populated areas where the need for traffic capacity is relatively low. A large radio coverage area will thus ensure that the number of base stations needed to serve a particular area will stay relatively low, which of course will keep the costs as low as possible.

The transmission power used by the transmitter of the base station has naturally a significant influence on the size of the radio coverage area of a base station. One of the problems with known base stations are, however, the feeder losses from the transmitter to the antenna. These feeder losses are mainly caused by the cable interconnecting the transmitter with the antenna and by passband filters/duplex filters adapted in the antenna mast. To increase the radio coverage area simply by increasing the transmission power of the transmitter in the base station would thus also lead to increased feeder losses.

The object of the present invention is to solve the above mentioned problem and to provide a base station with an increased radio coverage area though the losses of the base station in question are not significantly greater than those of previously known base stations. These and other objects of the invention are achieved with the base station of the present invention which is characterized in said amplifying means comprise: a variable gain amplifier, first sampling means for sampling the signals fed to an input of the amplifier via said cable, second sampling means for sampling the signals forwarded from an output of the amplifier to an antenna, and adjustment means being responsive to said first and -second sampling means for adjusting the gain of said amplifier in order to obtain a fixed gain.

The invention is based on the idea that the radio coverage area of a base station can be increased without simultaneously increasing the feeder losses from transmitter to antenna by providing the antenna means with the final amplifying stage and with adjustment means for sampling the output and input signals to the amplifier and adjustment means for adjusting the gain of said amplifier in order to obtain a fixed gain. Thus the invention ensures that the mast head amplifier is transparent to the RF transmitter signal, except for the increase in RF power delivered to the antenna. This makes it possible to use an ordinary known base station equipment directly in the base station of to the present invention as no complex links are needed between the base station equipment and the amplifier of the antenna means.

The most significant advantages with the base station according to the present invention are that the EIRP (Effective Isotropic Radiated Power) and the radio coverage area of the base station can be increased without any need to increase the transmission power of the transmitter in the base station equipment and thus without increasing the feeder losses and that the invention can be utilized with any conventional existing base station without a need for any significant modifications of the existing base station equipment as the mast head amplifier is transparent to the RF transmitter located in the actual base station equipment.

The advantageous embodiments of the base station according to the invention appear from the appended dependent claims 2 to 5.

In the following the base station of the present invention is described in more detail by means of a first preferred embodiment and with references to the attached drawings, in which

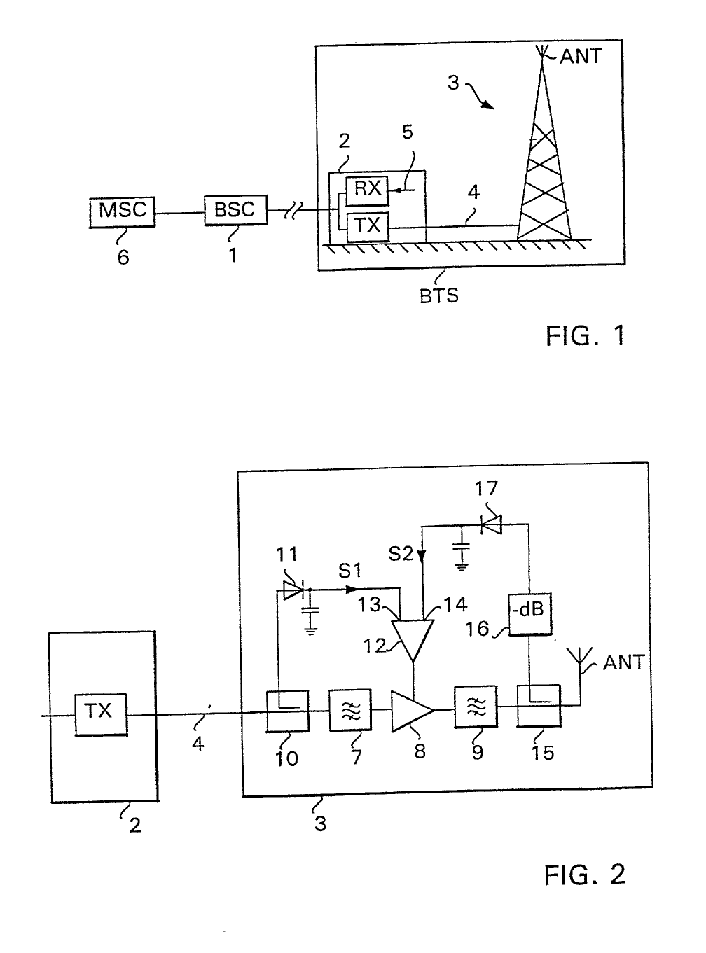

FIG. 1 illustrates a first preferred embodiment of a base station, and

FIG. 2 is a block diagram of the base station of FIG. 1.

FIG. 1 illustrates a first preferred embodiment of a base station. The base station BTS of FIG. 1 could be for instance a base station of the GSM cellular system (Groupe Special Mobile). The GSM system has been described in more detail for instance in the book “The GSM System for Mobile Communications”, M. Mouly and M-B. Pautet, Palaiseau, France, 1992, ISBN:2-9507190-0-7.

As any conventional base station also the base station BTS of FIG. 1 comprises a base station equipment 2 adapted at the foot of an antenna mast. The antenna means 3 of the base station BTS (which are located in the antenna mast) are thus adapted at a distance from said base station equipment 2 and connected by a cable 4 to the transmitter unit TX (or several transmitter units) of the base station equipment 2. The base station equipment 2 also comprises a receiver unit RX (or several receiver units) for receiving radio signals from mobile stations. The input 5 of the receiver RX can be connected to the antenna means 3, whereby the base station BTS can send and transmit signals with the same antenna ANT. In FIG. 1 it is however by way of example assumed that the input 5 of the receiver is connected to an other antenna, which means that the antenna ANT of FIG. 1 is used only for transmitting signals. The base station BTS of FIG. 1 is thus adapted to forward telecommunication signals between the Mobile Switching Centre 6 (via the Base Station Controller 1) and mobile stations within the radio coverage area of the base station BTS.

FIG. 2 is a block diagram of the base station of FIG. 1. Only the transmission part of the base station is shown in FIG. 2. The RF signals forwarded to the antenna means 3 from the transmitter TX of the base station equipment 2 via the feeder cable 4 are filtered with a passband filter 7 and fed to the input of a variable gain amplifier 8. The amplified signals outputted from the amplifier 8 are fed via a second passband filter 9 to the antenna ANT. The antenna means 3 thus comprise an RF amplifier of high gain to increase the RF signal to the antenna and to thus increase the radio coverage area of the base station.

The amplifier 8 should be an almost linear amplifier. Otherwise distortion might occur in the modulation, and deviation will be made away from the absolute power levels under dynamic control conditions.

The antenna means 3 of the base station of FIG. 2 further comprise adjustment means 10-13 for adjusting the gain of the variable gain amplifier 8. Thus the antenna means 3 include a first directional coupler 10 which samples signals fed from the transmitter TX to the input of amplifier 8. The directional coupler 10 and the diode detector 11 detector generate a first sample signal S1 (a video voltage) which is fed to a first input 13 of an error amplifier 12.

The antenna means 3 also include a second directional coupler 15 which samples the output power of the signals forwarded to the antenna ANT. The directional coupler 15 is thus feeding a sample signal to the attenuator 16. Attenuator 16 is adapted to give an attenuation equal to the nominal gain of the linear amplifier 8. The attenuated signal is fed from the attenuator 16 to a second diode 17. The diode 17 provides a video detected voltage derived from the RF output, in other words a second samples signal S2 which is fed to a second input 14 of the error amplifier 12.

The error amplifier 12 output is used to control the gain of the RF amplifier 8. A constant error signal is thus maintained, providing fixed gain. Thus frequency response gain slope and temperature effects are eliminated, and the effect of the masthead amplifier is transparent to the base station equipment 2 apart from increased RF gain and output power.

It is to be understood that the above description and the figures related thereto are only meant to illustrate one preferred embodiment of the invention without restricting the invention itself thereto. Thus the base station of the invention can also be used in other radio systems than the GSM system. The preferred embodiments of the base station of the invention may thus vary within the scope of the appended claims.

1. Base station (BTS) of a radio system, comprising
a base station equipment (2) including at least one transmitter unit (TX), and
antenna means (3) adapted at a distance from said base station equipment (2) and connected by at least one cable (4) to the transmitter unit (TX) of said base station equipment for receiving signals fed by said transmitter unit (TX), said antenna means including amplifying means (8) for amplifying the signals received form the transmitter unit (TX) via said cable (4) and means for forwarding the amplified signals to receiver units within the radio coverage area of the base station (BTS),
chracterized in that said amplifying means comprise:
a variable gain amplifier (8),
first sampling means (10, 11) for sampling the signals fed to an input of the amplifier (8) via said cable (4),
second sampling means (15, 16, 17) for sampling the signals forwarded from an output of the amplifier (8) to an antenna (ANT), and
adjustment means (12) being responsive to said first and second sampling means for adjusting the gain of said amplifier (8) in order to obtain a fixed gain.

2. Base station according to claim 1, characterized in that
said adjustment means include an error amplifier (12) for producing and feeding an adjustment signal to an adjustment input of said variable gain amplifier (8) in response to a first (S1) and second (S2) sample signal fed to a first (13) and second (14) input of said error amplifier (12),
said first sampling means (10, 11) include a directional coupler for generating said first sample signal (Si) in response to the signal level of the signals received from the transmitter (TX) of the base station, and
said second sampling means (15, 16, 17) include a directional coupler for generating said second sample signal (S2) in response to the signal level of the signals fed to an antenna (ANT).

3. Base station according to claim 2, characterized in that said second sampling means include attenuator means (16) adapted to attenuate a sample signal by the nominal gain of said variable gain amplifier (8), said sample signal being obtained by a directional coupler (15) from the signals fed to the antenna.

4. Base station according to claim 1, characterized in that said amplifying means (8) are adapted to amplify signals received form said transmitter unit (TX) via said cable (4) with a constant gain.

5. Base station according to any of claims 1-4, characterized in that said base station (BTS) is a base station of the GSM cellular system.
